(19) United States
(12) Patent Application Publication
(10) Pub. No.: US 2016/0311098 A1
(43) Pub. Date: Oct. 27, 2016

(54) DRIVING-IN TOOL

(71) Applicant: HILTI AKTIENGESELLSCHAFT, Schaan (LI)

(72) Inventor: Matthias BLESSING, Frastanz (AT)

(21) Appl. No.: 15/104,360

(22) PCT Filed: Dec. 9, 2014
(86) PCT No.: PCT/EP2014/077070

§ 371 Date: Jun. 14, 2016

(30) Foreign Application Priority Data
Dec. 18, 2013 (EP) 13198044.3

(51) Int. Cl. B25C 1/14

(52) U.S. Cl. CPC B25C 1/143

(57) ABSTRACT

The invention relates to a driving-in tool, comprising a hand-held housing, having a piston member received therein for transferring energy to a fastening element to be driven in, an interchangeable propelling charge and a combustion chamber arranged between the propelling charge and the piston member, which preferably extends about a central axis (A), and an actuator by means of which the energy transferred from the propellant charge to the piston member can be variably adjusted, wherein a discharge channel connected to the combustion chamber can be unblocked by means of a movable slide of the actuator, wherein a start position of the piston member is variably adjustable by means of the slide.

The invention relates to a driving-in tool according to the preamble of the patent claim 1 and a system for driving in a fastening element into a workpiece according to the features of claim 10.

Hand-held driving-in tools with propelling charges are known from the state of the art, whereby after firing a pyrotechnic charge, the resulting combustion gases expand in a combustion chamber. In this way, a piston is accelerated as the energy transfer means and drives in a fastening means into a workpiece. Basically an as optimized as possible, residue-free and reproducible combustion of the charge is desired. It must be taken into account here that the charge normally comprises particles such as powder grains, fibers or the like, which after ignition initially are driven ahead of a flame front.

U.S. Pat. No. 6,321,968 B1 discloses a driving-in tool with a propelling charge, wherein the combustion chamber is separated into an upper chamber and a lower chamber by means of an orifice plate. Powder grains of the propelling charge are larger than the holes of the plate. Thus, the powder grains are first accelerated in a central discharge area onto the perforated areas of the separation plate, where they are retained due to the dimensioning of the holes of the separation plate, so that combustion of the powder grains takes place primarily in the upper chamber. In FIG. 10 a variation is shown in which a propelling charge is used without cartridge. In this variation, due to design no discharge area enclosing the central axis is provided in the upper chamber that extends between the propelling charge and a central area of the separation plate. The discharge area in the example of FIG. 10, therefore, does not include the central axis of the combustion chamber, but is arranged annularly around a central stem of the combustion chamber. In this case, the ignition of the cartridge-free charge occurs at an upper end of the central stem.

The U.S. Pat. No. 6,321,968 B1 also shows adjustability of a holdup volume to variably adjust the driving-in energy of the device. For this purpose, a valve-like slider can be adjusted in a drive-in axis in perpendicular direction. Here, the combustion chamber comprises also in the closed position of the slide a holdup formed as a recess in a side wall of the combustion chamber.

It is the problem addressed by the invention to provide a driving-in tool which enables an effective adjustment of a driving-in energy for a given propelling charge.

This problem is solved for an aforementioned driving-in device according to the invention with the characterizing features of claim 1. Due to the possibility to variably adjust a start position of the piston member by means of the slider, in addition to the effect of the discharge channel a reduction of the driving-in energy can occur. Thereby, the piston member moves forward, defined relative to a rearmost position by the same slide that controls the discharge channel. In such a moved forward position compared to a rearmost position of the piston member a larger initial volume of the combustion chamber is created. Furthermore, the remaining acceleration distance of the piston member is shortened by the moving forward.

A driving-in energy for the purpose of this invention is understood to mean the kinetic energy of a piston member at a given propelling charge hitting a given fastening means. Given these marginal conditions, the actuator makes it possible to variably adjust the resulting driving-in energy for the fastening means.

A piston member for the purpose of this invention is any possible means upon which kinetic energy is applied by the ignition of the charge, wherein said kinetic energy is ultimately transferred to the fastening means. Frequently, the piston member is designed as a particular cylindrical piston. Recesses or other structures may be provided in the piston base, which promote turbulence and uniform expansion of the combustion gases.

A fastening element for the purpose of this invention is understood to mean any anchoring that can be driven-in such as nail, bolt or screw.

A central axis for the purpose of this invention is at least a parallel axis to the movement of the fastening element that in particular passes through a center of the combustion chamber.

In a generally preferred embodiment of the invention the slide is movable parallel to the axis, which enables a simple and effective implementation. In an alternative embodiment of the invention, the slide is movable transverse to the axis, preferably perpendicular to the axis.

Preferred is the outlet cross section of a discharge channel, which is variably adjustable depending on the position of the slide. A discharge channel for the purpose of this invention is understood to mean a channel by means of which the combustion gases of the propelling charge are discharged in the surroundings or in any other large volume, such as gas storage for a piston return. This way, depending on the cross section of the discharge channel, a particularly large and rapid pressure loss of the combustion chamber can be achieved.

Generally advantageous is an additional volume of the combustion chamber that is continuously or stepwise adjustable by adjustment of the slider. An additional volume of the combustion chamber is understood to mean a closed volume that is provided in addition to a minimum volume of the combustion chamber. An additional volume in the strict sense of the invention thereby is a volume added to the combustion chamber, which is generated by a moving forward of the piston member relative to a rearmost position.

In a preferred embodiment of the invention already with the beginning of an adjustment of the slide from a closed position, on the one hand a piston member is moved forward, and on the other hand a partial cross section of the discharge channel is unblocked.

In an alternative embodiment, it can also be provided that by means of an adjustment of the slide starting from a closed position, initially an increasing additional volume of the combustion chamber is set, and that upon further adjustment of the slide the discharge channel is unblocked. Thereby, a particularly favorable control characteristic with a particularly large width of the energy adjustment can be achieved, in particular an at least approximately linear relationship between an adjusting range of the slide and the reducing of the driving-in energy can also be achieved for large areas of an energy adjustment. In another alternative embodiment, initially the discharge channel and on further adjustment of the slide, an increasing additional volume of the combustion chamber is unblocked.

In a general advantageous embodiment of the invention, the combustion chamber by means of a separating member comprising a plurality of perforations is divided into a first chamber that is adjacent to the propelling charge and at least a second chamber that is adjacent to the piston member, wherein in the first chamber a discharge area is provided for the propelling charge, which extends between the propelling charge and a central area of the separating member. The discharge area preferably comprises the central axis, i.e., the central axis passes through the discharge area.

Here, particularly preferred is the discharge area, which is limited on the central area of the separating member by a closed surface of the separating member. By providing the closed surface in the central area of the separating member, particles of the charge, which are discharged after ignition in the combustion chamber, initially are reflected or deflected irrespective of their size before they come into contact with one of the perforations. On this modified path the particles can then spread evenly in the upper chamber, while they are getting caught by a flame front and ignited as well.

Overall, this ensures a good and as complete combustion of the propelling charge as possible. This applies in particular when the driving-in energy is adjusted by the actuator to a small value, and therefore large additional volumes and/or discharge openings effect the combustion process of the propelling charge.

A discharge area for the purpose of this invention is a prismatic usually cylindrical space area whose cross section is defined by a surface of an ignited charge directed into the combustion chamber and which extends perpendicular to the surface. When the propelling charge is provided in form of a cartridge, the surface of the charge is defined herein as the exit surface of the opened cartridge. In this case, the discharge area is essentially cylindrically shaped. Its diameter corresponds to the internal diameter of the cartridge holder at its output direction of the piston member.

The central axis for the purpose of this invention runs as a focal point line through the discharge area but the central axis does not necessarily coincide with a movement axis of the piston member.

A separating member for the purpose of this invention is any structure by which the combustion chamber is divided in two chambers. Preferably, the separating member runs transverse to the central axis. It can for example be formed as a multiple perforated plate.

The central area of the separating member is preferably not perforated, so that at least a considerable portion of the initially discharged particles within the discharge area move through the first combustion chamber to the central area, without first entering through the separating member into the second chamber.

Preferably, the closed surface of the central area is larger than a cross-section area of the separating member with the discharge area.

In generally preferred embodiments of the invention, the central area of the separating member has a recess. By means of this recession a particularly good backscattering of the deflected particles and turbulence combustion gases can occur in the first chamber.

In a preferred advanced embodiment, the recess is formed as a cup-shaped recess in the separating member. This promotes a scattering and turbulence in particular.

To further improve the scattering and turbulence in a preferred embodiment in a central bottom area of the recess an uprising projection is formed. The projection can be for example conical.

Alternatively, or additionally, it is provided that the recess comprises a downward decreasing diameter, which also causes a good dispersion of powder grains and fuel gases.

In the interest of optimizing the effect of the recess to a large portion of the propelling charge it is preferably provided that a maximum diameter of the recess extending perpendicular to the central axis is not less than 80% of a maximum diameter of an opening of the propelling charge extending perpendicular to the axis. Particularly preferred is that the diameter of recess is larger than the diameter of the opening of the propelling charge.

To improve the swirling effect of the recess it is also preferably provided that a maximum depth of a recess measured in direction of the axis is not less than 30%, particularly preferred not less than 50% of a maximum diameter of the recess measured perpendicular to the axis.

Generally, advantageously provided is a bridge each between two adjacent perforations, wherein combustion gases of the propelling charge initially flow from the discharge area outward between the bridges, before they flow through the perforations in axial direction after the deflection. In this way, the deflection and turbulence of the combustion gases is further optimized and an unwanted ingress of large powder grains in the perforations is further reduced.

Generally preferred it can be provided that the perforations of the separating member comprise a cross section that is larger than a maximum cross section of particles of the propelling charge. This prevents clogging the perforations with combustion residues. By means of the additional features of the invention ingress of large powder grains in the second chamber is avoided despite relatively large perforations.

In the interests of simple assembly and maintenance, the separating member is preferably screwed in the combustion chamber using an external thread formed on it.

In a generally preferred embodiment of the invention it is provided that in normal operation with the same propelling charge a maximum driving-in energy adjustable by means of the actuator corresponds to at least the double of a minimum driving-in energy adjustable by means of the actuator. Preferably, the maximum driving-in energy is at least 2.5 times the minimum driving-in energy. In advantageous detail design the minimum driving-in energy is not more than 150 joules and the maximum driving-in energy is not less than 250 joules. Overall, this allows a very universal deployment of the driving-in tool, without having to keep a plurality of propelling charges of various strength, depending on the application available.

Generally, at least a partially automatic adjustment of driving-in energy can occur by means of an electronic device control. Necessary specifications for doing so, for example on type and dimensioning of the workpiece can be made by an operator. Alternatively or additionally, sensory information, for example about the type of the inserted fastening means, can be used.

The problem addressed by the invention for a system for the driving in of a fastening element into a workpiece is solved by the features of claim 13. Thereby, a driving-in tool according to the invention allows covering a large range of driving-in energies with only one propelling charge. Accordingly, the provision of other propelling charges for the operation of the tool can be dispensed with.

Other features and advantages of the invention arise from the embodiments and the dependent claims. Hereinafter several preferred embodiments of the invention are described and explained in more detail based on the attached drawings.

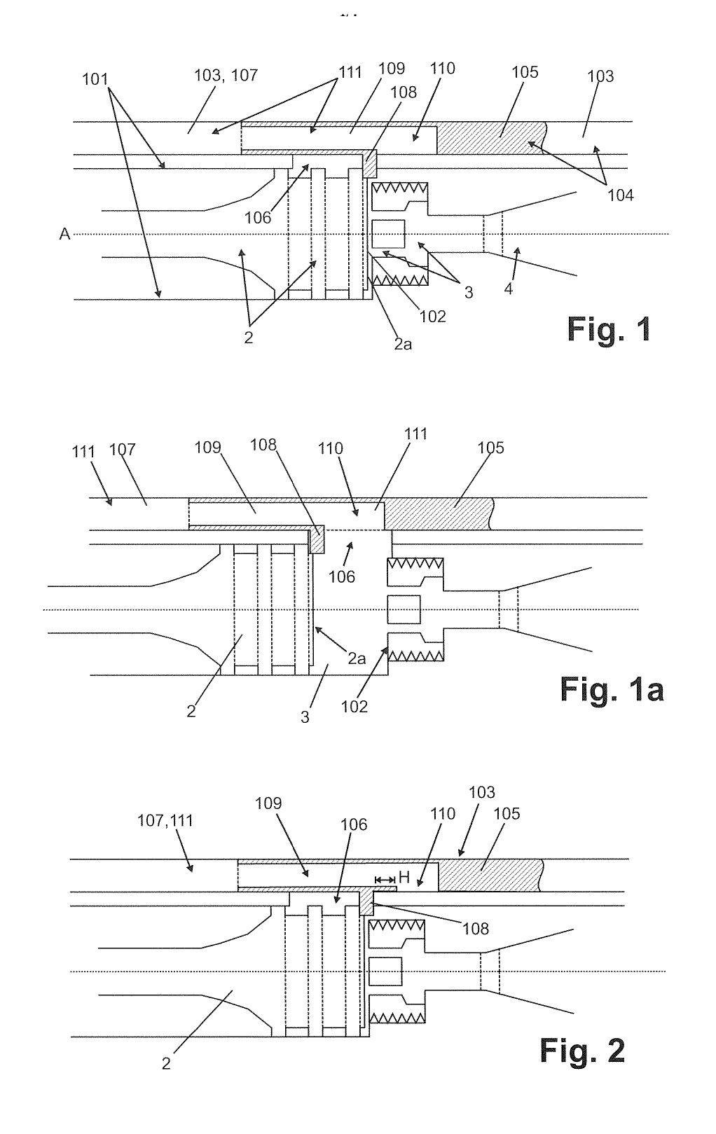

FIG. 1 shows a partial cross-sectional view of a combustion chamber of a driving-in tool with closed slide according to the invention.

FIG. 1a shows the driving-in tool of FIG. 1 with fully opened slide.

FIG. 2 shows a second embodiment of a driving-in tool.

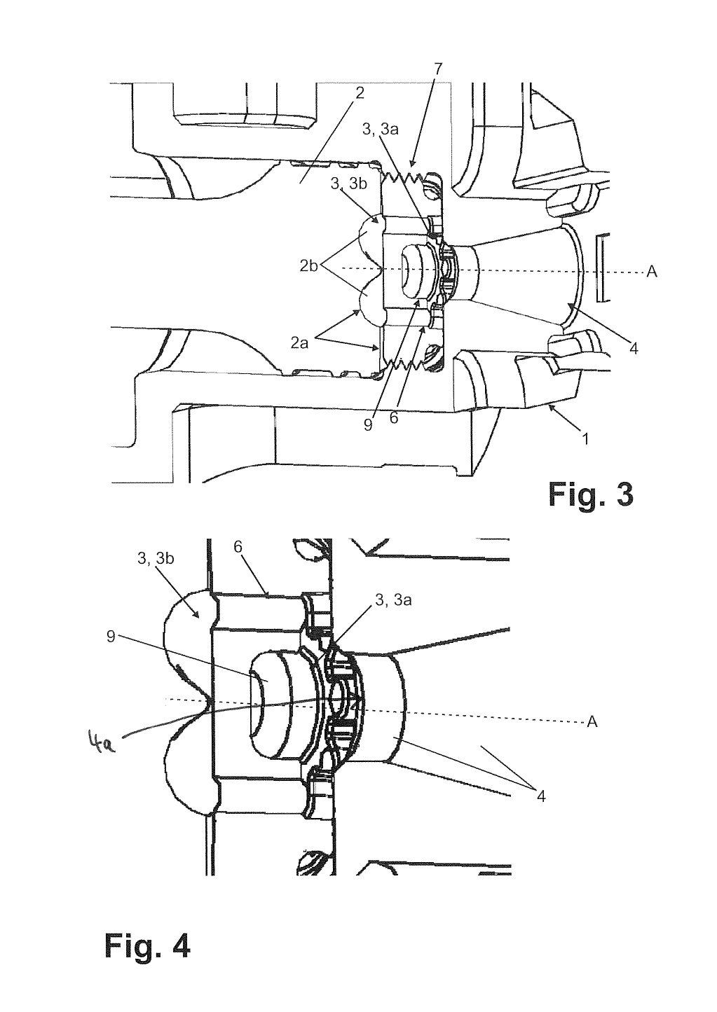

FIG. 3 shows a spatial cross-sectional view of a combustion chamber of a driving-in tool with a separating member.

FIG. 4 is a spatial detail view of the combustion chamber of FIG. 3.

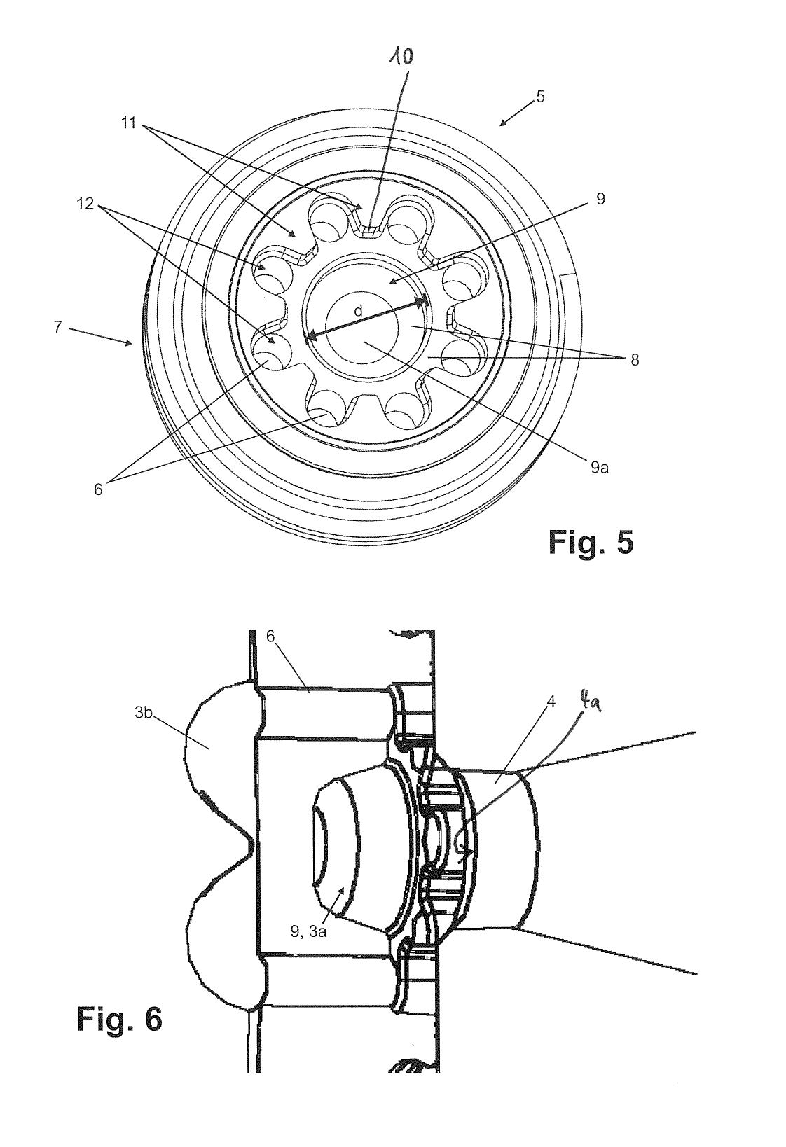

FIG. 5 is a spatial view of a separating member of the combustion chamber of FIG. 3.

FIG. 6 shows a spatial view of a combustion chamber with a second embodiment of a separating member.

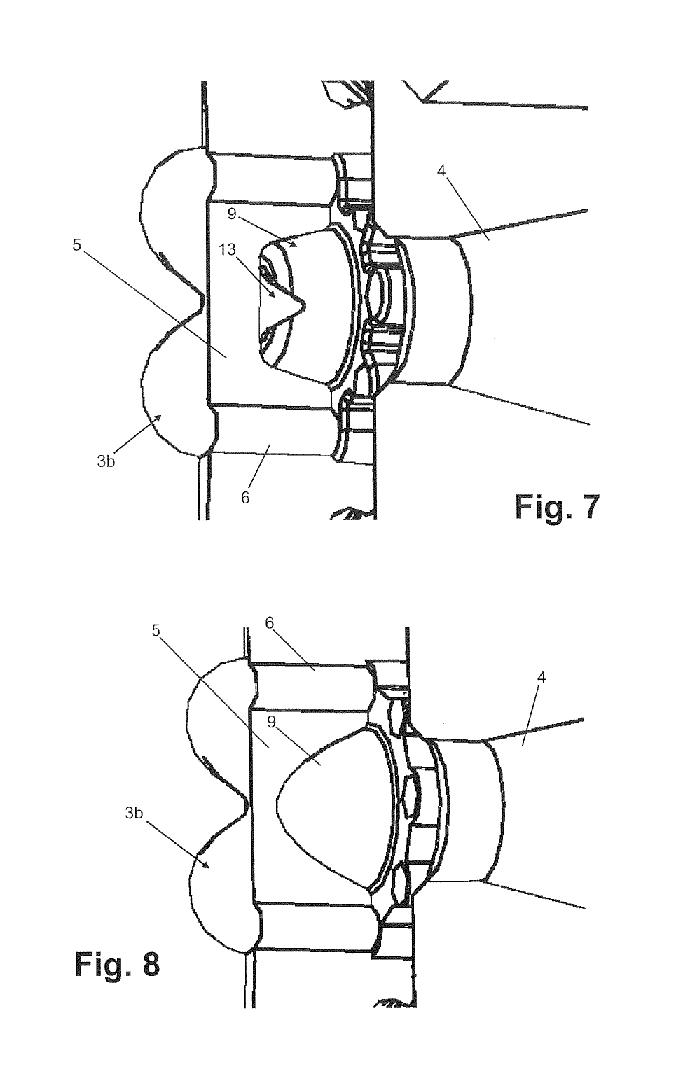

FIG. 7 shows a spatial view of a combustion chamber with a third embodiment of a separating member.

FIG. 8 shows a spatial view of a combustion chamber with a fourth embodiment of a separating member.

A driving-in tool according to the invention comprises a hand-held housing, having received a piston member in the form of a piston 2. A surface 2a of the piston 2 confines a combustion chamber 3, in which the combustion gases of a pyrotechnic charge expand to accelerate the piston 2. The pyrotechnic charge is solid, preferably powder. In not shown embodiments the pyrotechnic charge is liquid or gaseous.

The piston 2 upon which kinetic energy is applied with its piston shaft strikes upon a fastening element, which thereby is driven in a workpiece.

The charge in the present case is collected in a cartridge made of sheet metal. The cartridge has an impact fuse and is inserted in a cartridge holder 4 by a respective loading mechanism prior to the ignition.

Cartridge and cartridge holder are preferably designed rotationally symmetrical about a central axis A. In the present examples, the central axis A is at the same time a central axis of the combustion chamber 3 and the piston 2.

The combustion chamber 3 is arranged between a circular opening 4a of the cartridge holder 4 and the surface 2a of the piston 2. In a possible detail design an annular recess 2b is formed in the piston 2, which contributes to better turbulence of the combustion gases and represents a part of the combustion chamber 3.

The combustion chamber 3 in the present case comprises a side wall 101 that is designed as surface of revolution of a parallel about the central axis A, i.e. as inner cylinder. In addition, the combustion chamber 3 comprises a bottom surface 102, which is essentially extending perpendicular to the axis A.

For the adjustable modification of kinetic energy received by a piston member 2 at a given propelling charge, and thus for the modification of adjustable modification of a drive-in energy of the fastening means, an actuator 104 is provided. The actuator 104 comprises a recess 103 in parallel to the combustion chamber, in which a slide 105 is inserted. The actuator 104 also comprises a mechanism for adjusting a position of the slide 105 (not shown). The slide in FIG. 1 to FIG. 2 is provided with hatching to provide a better overview.

The slide 105 is received in the recess 103 of a housing enclosing the combustion chamber. In this recess the slide 103 is adjustable in its position in parallel to the central axis A. For this purpose, at a rear end of the slide 105, for example, an external thread is formed (not shown). The external thread can then run in an internal thread of an axially supported, rotatably mounted gear wheel. By means of a drive of the gear wheel, the slide 105 can be adjusted in the axial direction by the thread rotation. The design of the slide 105 adjusting mechanism is arbitrary.

Depending on requirements, the adjustment of the slide can be done manually, for example using a not-shown setting wheel. However, it can also be an adjustment by means of an electric actuator. At least a partially automatic adjustment of driving-in energy can occur here by means of an electronic device control. Necessary specifications for doing so, for example on type and dimensioning of the workpiece can be made by an operator. Alternatively or additionally, sensory information, for example about the type of the inserted fastening means, can be used.

The recess 103 is connected to the combustion chamber 3 via a perforation 106. In the driving-in direction a channel 107 leads in parallel to the combustion chamber towards the front.

The slide 105 fills the recess 103 and with a protruding pin 108 perpendicular to the axis A protrudes through the perforation 106 into the combustion chamber 3. The pin 108 also protrudes over an edge of a bottom 2a of the piston member 2, so that the piston member 2 hits on the pin 108 of the slide 105 in a movement opposite to the driving-in direction. Thereby, a rear position or start position of the piston member 2 is defined by the position of the slide 105 with the pin 108 before the drive-in process.

The slide also has a bore 109, which is open to the front and axially extending with a lateral opening 110, which is oriented in the direction of the perforation 106.

Depending on the position of the slide 105, the lateral opening 110 does not at all, partially or maximally cover the perforation 106. In this way, the volume of the combustion chamber 3 can be connected via an adjustable variable cross section with the bore 109 and the channel 107.

Therefore, the opening 110, the bore 109 and channel 107 form a discharge channel 111 at a corresponding position of the slide. After an ignition of the pyrotechnic propelling charge, the expanding gases can partially escape into the discharge channel, depending on its opening state. Thereby the kinetic energy or the driving-in energy ultimately received by the piston member 2 is reduced.

The discharge channel 111 leads into a not shown gas channel on a guide of the piston member 2 upstream of the combustion chamber 3. It ends in a known manner in a storage space (not shown). By means of the combustion gases collected in the storage space, the piston member 2 is moved back in the start position in a known manner at the end of the driving-in process. In alternative embodiments, the discharge channel 111 can also lead directly into the atmosphere.

With the slide 105 (see FIG. 1) fully closed in the initial state of the piston member 2, a bottom surface 2a of the piston member 2 is in contact with the bottom surface 102 of the combustion chamber 3. This means, a maximum acceleration of the piston member, a minimum initial volume of the combustion chamber at the time of the charge ignition and a fully closed discharge channel 111. Overall, a maximum driving-in energy is achieved thereby.

If the slide is moved further, starting from the closed position, the start position of the piston member 2 is moved forward. This results in a larger combustion chamber volume and a smaller acceleration distance of the piston member 2. Further, a pressure build-up in the combustion chamber 3 is reduced by a partial opening of the discharge channel 111. Overall, the achieved driving-in energy of the piston member 2 is thereby reduced.

In the fully open position of the slide 105 according to FIG. 1a there is a maximum open discharge channel 111 and a maximum moving forward of the piston member 2.

This results in a smallest possible value of the driving-in energy at a given propelling charge.

In the example of FIG. 1 and FIG. 1a, the slide is configured so that the discharge channel already opens at the start of the slide movement. Thus, each moving forward of the piston is also associated with an opening of the discharge channel.

In the case of the second embodiment according to FIG. 2, only the closed position of the slide 105 is shown. In this example, the opening 110 of the slide 105 is arranged offset. Thereby, an adjustment of the slide 105 can initially occur by a first stroke H, wherein the discharge channel 111 remains closed, but a moving forward of the piston member 2 already occurs. Only when exceeding this stroke H does the continuous opening of discharge channel 111 begin. Hereby, a particularly fine adjustment of the driving-in energy can occur overall.

In a variant not shown, it can also be provided that the slide 105 first opens the discharge channel and in the further course causes a moving forward of piston. This can be realized by a corresponding free travel of the pin 108 before reaching the maximum reset piston member 2.

The following description relates to optimized embodiments of the combustion chamber of the driving-in tool by means of a separating member. Although in the drawings FIG. 3 to FIG. 8 no actuator for modification of the driving-in energy is shown, the embodiments of the combustion chamber with separating member can be combined with any of the configurations described above of an actuator 104 depending on the requirements.

The combustion chamber 3 is divided transversely to the central axis A by a separating member 5. On the side of the cartridge holder 4 there is a first chamber 3a of the combustion chamber, and on the side of the piston 2 there is a second chamber 3b of the combustion chamber 3.

In the shown figures FIG. 3 to FIG. 8 the piston is maximally retracted, so that the second chamber 3b at the time of ignition comprises only the recess 2b, and at most a narrow gap between the piston 2 and the separating member 5.

The separating member 5 in the present case is formed as a component that by means of an external thread 7 can be screwed in the combustion chamber 3. The separating member can however also be formed integrally with the rest of the combustion chamber or be connected in any other way as a separate component with the combustion chamber.

The separating member 5 comprises a plurality of perforations 6, which in the present case are designed as bores which run parallel to the axis A. The perforations 6 are arranged around a central area 8 of the separating member 5, which comprises a closed and not perforated surface. The smallest diameter of the central, not perforated area 8 in a plane perpendicular to the axis A is about 35% larger than a diameter of the opened cartridge after ignition. In the present case this corresponds approximately to the diameter of an opening on the combustion chamber side of the cartridge holder or a surface of the pyrotechnic charge directed into the combustion chamber.

In the present case it is ideally assumed that the combustion gases and the powder grains, charge particles or the like ejected with them initially enter in the combustion chamber parallel to the central axis. At least immediately after the ignition and for a certain length, the expanding charge therefore moves mostly in a prismatic discharge area along the central axis, whose circumference is defined by the contour of the surface of the charge. In the present embodiments of the invention all of the perforations 6 of the separating member are outside of a cross section area of the discharge area with the surface of the separating member. The discharge area is formed according to the circular cartridge opening as a cylinder.

Further, a recess 9 is formed in the central area 8 of the separating member 5. The recess 9 runs rotationally symmetrical about the central axis A. It is formed cup-shaped, and has a flat bottom 9a. A diameter of the recess 9 tapers from a largest diameter d at its upper edge to a smallest diameter at the level of the bottom 9a. The walls of the recess 9 comprise both inclined and straight sections. The maximum depth of the recess 9 in the present case is about 60% of the largest diameter d.

In the plane of the upper edge of the recess 9 the closed surface of the central area 8 extends up to a gradation 10. The gradation 10 rises from the surface of the central area 8 in axial direction to a roof of the combustion chamber 3. The separating member 5 with the gradation 10 is in the present case pressed against the roof. This is achieved by screwing the separating member 5 accordingly in the combustion chamber 3.

The gradation 10 forms between the adjacent perforations 6 respective bridges 11 which are directed inward radially. Accordingly, radially directed channels 12 remain between the bridges 11, through which the combustion gases and charge particles initially flow radially outward from the central area 8 and are then deflected into the perforations 6.

The invention functions in relation to the separating member as follows:

After ignition of the cartridge, unburned particles are thrown before a front of combustion gases through the front cartridge opening in the first chamber 3a. This partially still unburned charge arrives after a short distance at the cup-shaped recess 9 of the closed central area 8 of the separating member 5. There, a scattering and turbulence of the powder grains and combustion gases occurs, wherein the powder grains continue to ignite and burn. This reacting and expanding mixture enters in a predominantly radial direction between the bridges 11 and is deflected into the perforations 6.

When flowing through the perforations 6, the particles of the charge area mostly burned already, so that neither in the perforations nor in the subsequent, second chamber 3b larger unburnt charge residues are present. This prevents unfavorable deposits and/or clogging of the perforations 6. At the same time, a controlled and uniform expansion of the combustion gases in the second chamber is promoted, so that an optimum acceleration of the piston 2 occurs.

In the second embodiment of a separating member shown in FIG. 6, another other shaping of the recess 9 is provided. As in the first example, the recess is formed as a cup-shaped recess, wherein however the walls of the recess are strongly and continuously inclined.

In the embodiment of a separating member shown in FIG. 7, the shaping of the recess 9 is prevalent as in the example of FIG. 6. In addition, over the bottom of the recess an uprising cone-shaped projection 13 is formed. Due to the cone-shaped projection 13, there is a strong scattering and turbulence of the combustion gases.

In the embodiment of a separating member shown in FIG. 8, the recess 9 has no even bottom, but comprises an overall nearly parabolic cross section. Such a shaping is especially well suited to avoid deposits.

It is understood that the invention is not limited to the shown, exemplary shaping of recess 9.

Overall, with the driving-in tool, as described above, in connection with a propelling charge and a variety of fastening means a system for driving in of a fastening element into a workpiece is provided. The system comprises a plurality of different fastening means, wherein only one type of propelling charge is needed to cover a full range of drive-in energies.

The drive-in energy transferred to the piston member, when using the same propelling charge, extends from a minimum driving-in energy of 90 joules to a maximum driving-in energy of 325 joules.

1. A drive-in tool, comprising
a hand-held housing, having a piston member received therein for transferring energy to a fastening element to be driven in, the piston member having a start position; an interchangeable propelling charge;
a combustion chamber arranged between the propelling charge and the piston member, which extends about a central axis (A);
and an actuator for variably adjusting energy transferred from the propelling charge to the piston member, the actuator having a movable slide, wherein a discharge channel connected to the combustion chamber can be unblocked by the movable slide;
wherein the start position of the piston member is variably adjustable by the slide.

2. The drive-in tool according to claim 1, wherein the slide is movable parallel to the axis (A).

3. The drive-in tool according to claim 1, wherein the slide is movable transversely to the axis (A).

4. The drive-in tool according to claim 1, wherein the combustion chamber has an adjustable volume that is adjustable by moving the slide.

5. The drive-in tool according to claim 1, wherein by adjusting the slide starting from a closed position, an increasing additional volume of the combustion chamber is initially adjusted, and on further adjusting the slide, the discharge channel is unblocked.

6. The drive-in tool according claim 1, wherein by adjusting the slide starting from a closed position, the discharge channel is initially unblocked and on further adjusting the slide, an increasing additional volume of the combustion chamber is unblocked.

7. The drive-in tool according to claim 1, wherein by adjusting the slide starting from a closed position, an increasing additional volume of the combustion chamber and the discharge channel are unblocked at the same time.

8. The drive-in tool according to claim 1, wherein
the combustion chamber by a separating member comprising a plurality of perforations and a central area, is divided into a first chamber adjacent to the propelling charge, and at least one second chamber adjacent to the piston member,
wherein a discharge area for the propelling charge particularly encompassing the central axis (A) is provided in the first chamber, which extends between the propelling charge and the central area of the separating member.

9. The drive-in tool according to claim 8, wherein the discharge area on the central area of the separating member is confined by a closed surface of the separating member.

10. The drive-in tool according to claim 8, wherein the central area of the separating member comprises a recess.

11. The drive-in tool according to claim 1, wherein in normal operation with the same propelling charge, an adjustable maximum driving-in energy adjustable by the actuator corresponds to at least the double of a minimum driving-in energy adjustable by the actuator.

12. The drive-in tool according to claim 11, wherein the minimum driving-in energy is not more than 150 joules and the maximum driving-in energy is not less than 250 joules.

13. A system for driving in of a fastening element into a workpiece, comprising the drive-in tool according to claim 1, and a plurality of different fastening means, wherein the system comprises only one type of propelling charge with essentially the same propelling charge energy.

14. The drive-in tool according to claim 2, wherein moving the slide adjustably sets an exit cross section of an exhaust channel.

15. The drive-in tool according to claim 3, wherein the slide is movable perpendicular to the axis.

16. The drive-in tool according to claim 3, wherein moving the slide adjustably sets an exit cross section of an exhaust channel.

17. The drive-in tool according to claim 2, wherein the combustion chamber has an adjustable volume that is adjustable by moving the slide.

18. The drive-in tool according to claim 3, wherein the combustion chamber has an adjustable volume that is adjustable by moving the slide.

19. The drive-in tool according to claim 9, wherein the central area of the separating member comprises a recess.

20. The drive-in tool according to claim 2, wherein in normal operation with the same propelling charge, an adjustable maximum driving-in energy adjustable by the actuator corresponds to at least the double of a minimum driving-in energy adjustable by the actuator.
